(19) United States
(12) Patent Application Publication
(10) Pub. No.: US 2024/0193253 A1
(43) Pub. Date: Jun. 13, 2024

(54) INFORMATION PROCESSING APPARATUS, CONTROL METHOD FOR INFORMATION PROCESSING APPARATUS, AND STORAGE MEDIUM

(71) Applicant: CANON KABUSHIKI KAISHA, Tokyo (JP)

(72) Inventor: Jun Nakagawa, Kanagawa (JP)

(21) Appl. No.: 18/527,069

(22) Filed: Dec. 1, 2023

(30) Foreign Application Priority Data
Dec. 9, 2022 (JP) 2022-196853

(51) Int. Cl. G06F 21/44

(52) U.S. Cl. CPC G06F 21/44; H04N 5/907

(57) ABSTRACT

An information processing apparatus to which an external storage medium is connectable includes a setting information storage unit that stores setting information, an attachment/detachment detection unit that detects attachment to and detachment from the information processing apparatus of the external storage medium, a notification unit that provides notification of detachment of the external storage medium from the information processing apparatus, and an invalidation unit that invalidates the setting information based on the notification of the detachment of the external storage medium from the information processing apparatus.

### BACKGROUND

### Field

The present disclosure relates to an information processing apparatus, a control method for the information processing apparatus, and a storage medium.

### Description of the Related Art

In recent years, information processing apparatuses, especially image capturing apparatuses such as digital cameras and mobile devices equipped with digital cameras, have become widespread, which has led to an increase in the number of pictures taken by individuals, and it is common practice to share these images over the Internet. There are many image capturing apparatuses equipped with functions of enabling a user to easily take a favorite picture and to organize pictures object by object by registering a development parameter and face recognition information therein.

In order to realize these functions, authentication information, setting information such as a development parameter, personal information, and the like, which are information that a user of an image capturing apparatus wants to conceal, are stored in the image capturing apparatus. There is a risk that the above-described information can be leaked to a third party if the image capturing apparatus is sold as a used item without being initialized.

In order to address such issues, according to Japanese Patent Application Laid-Open No. 2007-241383, a method is discussed where a previous owner's information is deleted by overwriting it with a new owner's information.

According to Japanese Patent Application Laid-Open No. 2007-241383, the previous owner's information is not deleted until the new owner registers the new owner's information, so that it is not possible to prevent a risk of the previous owner's information being misused if the new owner has malicious intent. Because the new owner can start to use an image capturing apparatus, such as a commonly used digital camera, without registering the new owner's information, there is a possibility that previous owner's information can be misused.

### SUMMARY

The present disclosure is directed to improvement of security of setting information stored in an information processing apparatus.

According to an aspect of the present disclosure, an information processing apparatus to which an external storage medium is connectable includes a setting information storage unit store configured to setting information, an attachment/detachment detection unit configured to detect attachment to and detachment from the information processing apparatus of the external storage medium, a notification unit configured to provide notification of detachment of the external storage medium from the information processing apparatus. and an invalidation unit configured to invalidate the setting information based on the notification of the detachment of the external storage medium from the information processing apparatus.

Further features of the present disclosure will become apparent from the following description of exemplary embodiments with reference to the attached drawings.

### BRIEF DESCRIPTION OF THE DRAWINGS

FIG. 1 is a block diagram illustrating an example of a configuration of an image capturing apparatus according to a first exemplary embodiment.

FIG. 2 is a flowchart illustrating processing from generation to deletion of setting information executed by the image capturing apparatus according to the first exemplary embodiment.

FIG. 3 is a flowchart illustrating an example of operations of setting information duplication executed by the image capturing apparatus according to the first exemplary embodiment.

FIG. 4 is a block diagram illustrating an example of a configuration of an image capturing apparatus according to a second exemplary embodiment.

FIG. 5 is a flowchart illustrating processing from generation to deletion of setting information executed by the image capturing apparatus according to the second exemplary embodiment.

FIG. 6 is a flowchart illustrating an example of operations of setting information initialization by the image capturing apparatus according to the second exemplary embodiment.

FIG. 7 is a flowchart illustrating an example of operations of setting information duplication executed by the image capturing apparatus according to the second exemplary embodiment.

FIG. 8 is a block diagram illustrating an example of a configuration of an image capturing apparatus according to a third exemplary embodiment.

FIG. 9 is a flowchart illustrating processing from generation to deletion of setting information executed by the image capturing apparatus according to the third exemplary embodiment.

FIG. 10 is a flowchart illustrating an example of operations of setting information duplication executed by the image capturing apparatus according to the third exemplary embodiment.

### DESCRIPTION OF THE EMBODIMENTS

### [Apparatus Configuration]

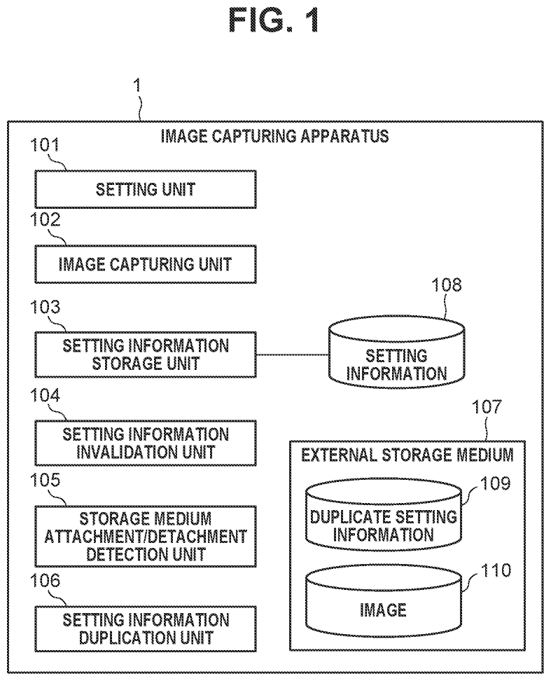

A first exemplary embodiment will now be described. FIG. 1 is a block diagram illustrating a configuration example of an image capturing apparatus 1 as an example of an information processing apparatus according to the present exemplary embodiment. The image capturing apparatus 1 includes a setting unit 101, an image capturing unit 102, a setting information storage unit 103, a setting information invalidation unit 104, a storage medium attachment/detachment detection unit 105, a setting information duplication unit 106, and an external storage medium 107.

The setting unit 101 generates setting information 108 such as an image capturing parameter in the image capturing apparatus 1 via a user operation.

The image capturing unit 102 generates an image 110 using a function of capturing a picture, a moving image, and the like.

The setting information storage unit 103 stores the setting information 108.

The setting information invalidation unit 104 invalidates the setting information 108 stored in the setting information storage unit 103.

The storage medium attachment/detachment detection unit 105 detects attachment and detachment of the external storage medium 107 to and from the image capturing apparatus 1. The storage medium attachment/detachment detection unit 105 operates even in a state in which the image capturing apparatus 1 is not started (un-started state).

The setting information duplication unit 106 has a function of duplicating the setting information 108 to generate duplicate setting information 109 or duplicating the duplicate setting information 109 to generate the setting information 108.

The external storage medium 107 is a storage medium that can be attached to and detached from the image capturing apparatus 1 and is, for example, a secure digital (SD) card or a compact flash (CF) card. The external storage medium 107 can also be a solid state disk (SSD), a Universal Serial Bus (USB) flash memory, a hard disk, a compact disk (CD), a digital versatile disk (DVD), a Blu-ray disc, or the like. The SD card includes an SD high capacity (SDHC) card, an SD extended capacity (SDXC) card, a micro SD card, a micro SDHC card, or a micro SDXC card. The external storage medium 107 mainly stores the duplicate setting information 109 and the image 110.

### [Setting Information Deletion]

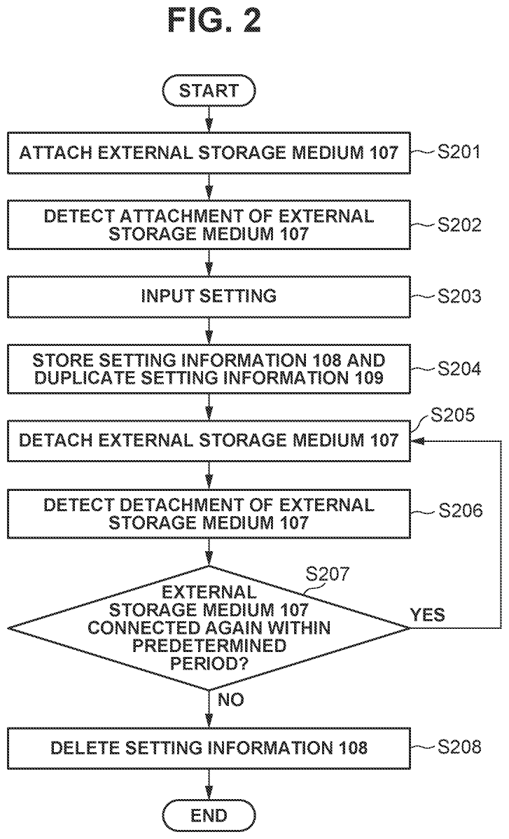

FIG. 2 is a flowchart illustrating processing from generation to deletion of setting information executed by the image capturing apparatus 1.

In step S201, the external storage medium 107 is attached to the image capturing apparatus 1.

In step S202, the storage medium attachment/detachment detection unit 105 detects that the external storage medium 107 is attached to the image capturing apparatus 1. The storage medium attachment/detachment detection unit 105 notifies the setting unit 101 that attachment of the external storage medium 107 is detected. After receiving the notification that attachment of the external storage medium 107 is detected, the setting unit 101 starts receiving input of setting information from a user. In a case where the external storage medium 107 is attached to the image capturing apparatus 1 when the image capturing apparatus 1 has not been started, the detection is performed, but the notification to the setting unit 101 is performed after the image capturing apparatus 1 is started.

In step S203, the setting unit 101 receives input of the setting information from the user and generates the setting information 108. In step S204, the setting unit 101 stores the setting information 108 in the setting information storage unit 103. The setting information 108 includes a development parameter, parameter information for various types of image capturing, authentication information for connecting to an external server, and personal information such as face recognition information. In step S204, the setting information duplication unit 106 duplicates the setting information 108 to generate the duplicate setting information 109, and the external storage medium 107 stores the duplicate setting information 109.

In step S205, the external storage medium 107 is detached from the image capturing apparatus 1.

In step S206, the storage medium attachment/detachment detection unit 105 detects that the external storage medium 107 is detached from the image capturing apparatus 1 and notifies the setting unit 101 that detachment of the external storage medium 107 is detected. After receiving the notification that detachment of the external storage medium 107 is detected, the setting unit 101 stops receiving input of setting information from the user. In a case where the external storage medium 107 is detached from the image capturing apparatus 1 when the image capturing apparatus 1 has not been started, the detection is performed, but the notification to the setting unit 101 is performed after the image capturing apparatus 1 is started.

In step S207, in a case where the external storage medium 107 remains in a detached state for a predetermined period of time (NO in step S207), the storage medium attachment/detachment detection unit 105 notifies the setting information invalidation unit 104 that detachment of the external storage medium 107 is detected. In a case where the external storage medium 107 is detached from the image capturing apparatus 1 when the image capturing apparatus 1 has not been started, it is determined whether the detached state has continued for the predetermined period of time, but the notification to the setting information invalidation unit 104 is performed after the image capturing apparatus 1 is started.

In step S208, after receiving the notification that detachment of the external storage medium 107 is detected, the setting information invalidation unit 104 deletes the setting information 108 stored in the setting information storage unit 103. Deletion of the setting information according to the present exemplary embodiment only needs to invalidate the setting information 108 stored in the setting information storage unit 103. For example, invalidating a data file of the setting information 108 without deleting it by editing management information of the setting information 108 can be regarded as deletion.

### [Setting Information Duplication]

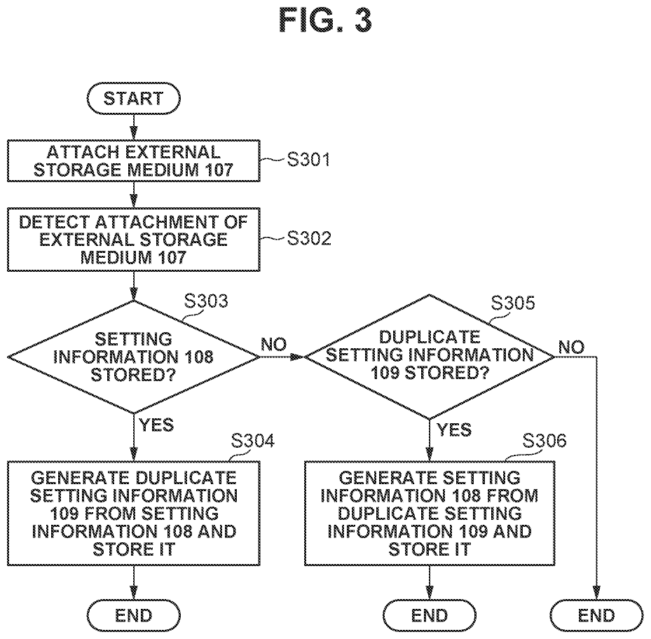

FIG. 3 is a flowchart illustrating an example of setting information duplication executed by the image capturing apparatus 1.

In step S301, the external storage medium 107 is attached to the image capturing apparatus 1.

In step S302, the storage medium attachment/detachment detection unit 105 detects that the external storage medium 107 is attached to the image capturing apparatus 1 and notifies the setting information duplication unit 106 that attachment of the external storage medium 107 is detected. In a case where the external storage medium 107 is attached to the image capturing apparatus 1 when the image capturing apparatus 1 has not been started, the detection is performed, but the notification to the setting information duplication unit 106 is performed after the image capturing apparatus 1 is started.

In step S303, the setting information duplication unit 106 determines whether the setting information 108 is stored in the setting information storage unit 103. In a case where the setting information 108 is stored (YES in step S303), the processing proceeds to step S304. In a case where the setting information 108 is not stored (NO in step S303), the processing proceeds to step S305.

In step S304, the setting information duplication unit 106 duplicates the setting information 108 to generate the duplicate setting information 109. The generated duplicate setting information 109 is stored in the external storage medium 107. In a case where valid duplicate setting information 109 is stored in the external storage medium 107, the duplicate setting information 109 is overwritten and stored.

In step S305, the setting information duplication unit 106 determines whether the duplicate setting information 109 is stored in the external storage medium 107. In a case where the duplicate setting information 109 is stored (YES in step S305), the processing proceed to step S306.

In step S306, the setting information duplication unit 106 duplicates the duplicate setting information 109 to generate the setting information 108. The generated setting information 108 is stored in the setting information storage unit 103.

According to the present exemplary embodiment, the storage medium attachment/detachment detection unit 105 detects detachment of the external storage medium 107 and uses the detection as a trigger to delete the setting information 108 stored in the setting information storage unit 103, so that leakage, unauthorized use, and misuse of the setting information can be avoided. A period of time is provided between detecting detachment of the external storage medium 107 and deleting the setting information 108 so that it is possible to prevent the setting information 108 from being deleted if a user temporarily detaches the external storage medium 107. The setting information duplication unit 106 has the function of mutually duplicating the setting information 108 and the duplicate setting information 109 so that in a case where the setting information 108 is deleted from the image capturing apparatus 1, the setting information 108 is restored from the duplicate setting information 109. In a case where the external storage medium 107 is replaced with a new storage medium, the duplicate setting information 109 is regenerated from the setting information 108, and thus the setting information 108 can be prevented from being unintentionally lost.

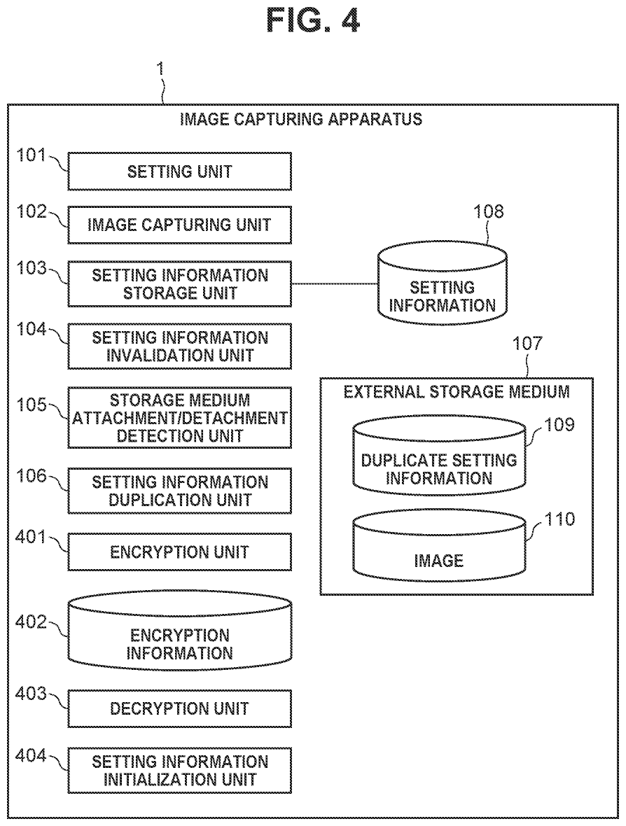

A second exemplary embodiment will now be described. FIG. 4 is a block diagram illustrating an example of a configuration of an image capturing apparatus 1 according to the present exemplary embodiment. The image capturing apparatus 1 in the present exemplary embodiment includes an encryption unit 401, a decryption unit 403, encryption information 402, and a setting information initialization unit 404 in addition to the functions described in the first exemplary embodiment.

The encryption unit 401 encrypts the setting information generated by the setting unit 101 using the encryption information 402 to generate encrypted setting information 108. According to the present exemplary embodiment, it is assumed that the setting information 108 stored in the setting information storage unit 103 is encrypted by the encryption unit 401.

The decryption unit 403 decrypts the encrypted setting information 108.

The encryption information 402 is, for example, a common key in a common key encryption method and a public key and a secret key in a public key encryption method, and is an encryption key unique to the image capturing apparatus 1.

The setting information initialization unit 404 invalidates the duplicate setting information 109 by deleting the setting information 108 and regenerating the encryption information 402.

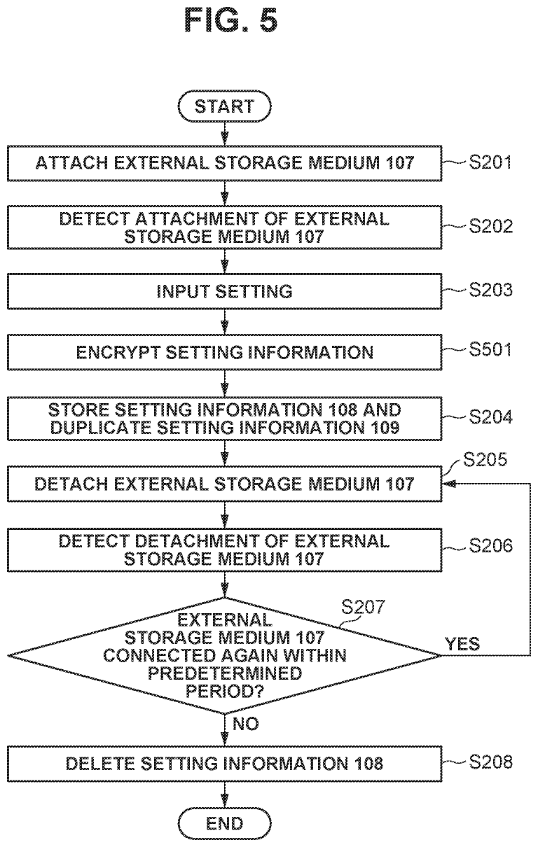

FIG. 5 is a flowchart illustrating processing from generation to deletion of the setting information executed by the image capturing apparatus 1 according to the present exemplary embodiment. According to the present exemplary embodiment, processing in step S501 is added to the flow described in the first exemplary embodiment.

In step S501, the encryption unit 401 encrypts the setting information input in step S203, and in step S204, the encrypted setting information 108 is stored in the setting information storage unit 103. In step S204, the setting information duplication unit 106 duplicates the setting information 108 to generate encrypted duplicate setting information 109 similar to the setting information 108, and the external storage medium 107 stores the encrypted duplicate setting information 109.

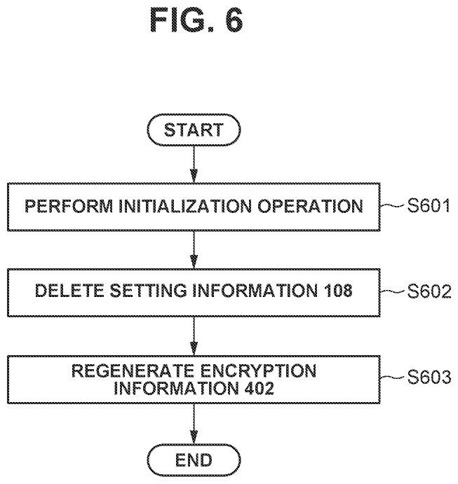

FIG. 6 is a flowchart illustrating an example of setting information initialization executed by the image capturing apparatus 1 according to the present exemplary embodiment.

In step S601, the setting information initialization unit 404 receives an initialization operation from a user.

In step S602, the setting information initialization unit 404 deletes the setting information 108 from the setting information storage unit 103.

In step S603, the setting information initialization unit 404 deletes the encryption information 402 and generates new encryption information 402 unique to the image capturing apparatus 1.

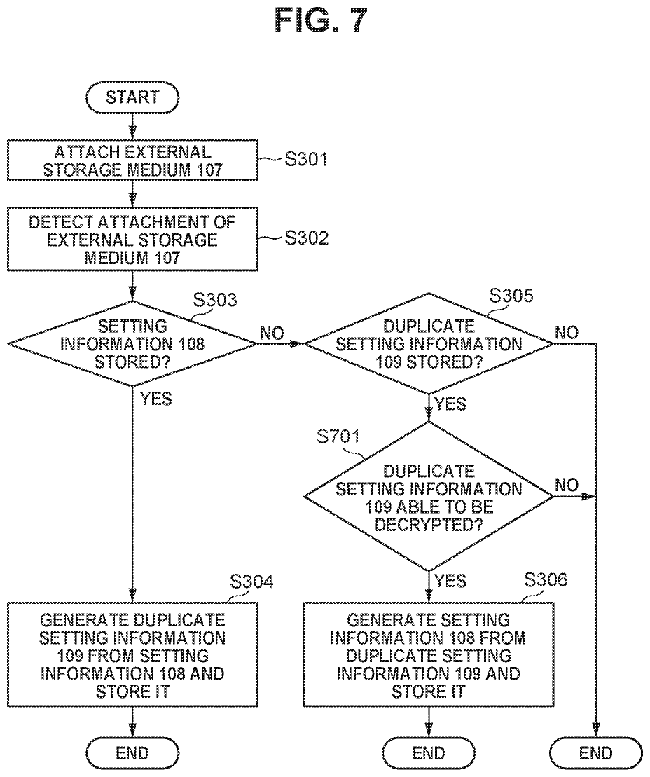

FIG. 7 is a flowchart illustrating an example of setting information duplication executed by the image capturing apparatus 1 according to the present exemplary embodiment. According to the present exemplary embodiment, processing in step S701 is added to the flow described in FIG. 3.

In step S701, the decryption unit 403 determines whether the duplicate setting information 109 can be decrypted.

In a case where the duplicate setting information 109 can be decrypted (YES in step S701), the processing proceeds to step S306, and in a case where the duplicate setting information 109 cannot be decrypted (NO in step S701), the processing ends.

According to the present exemplary embodiment, the setting information is encrypted using the encryption information unique to the image capturing apparatus to enable preventing the setting information stored in the external storage medium from being used in another image capturing apparatus or the like. The setting information stored in the external storage medium can also be invalidated by regenerating the encryption information.

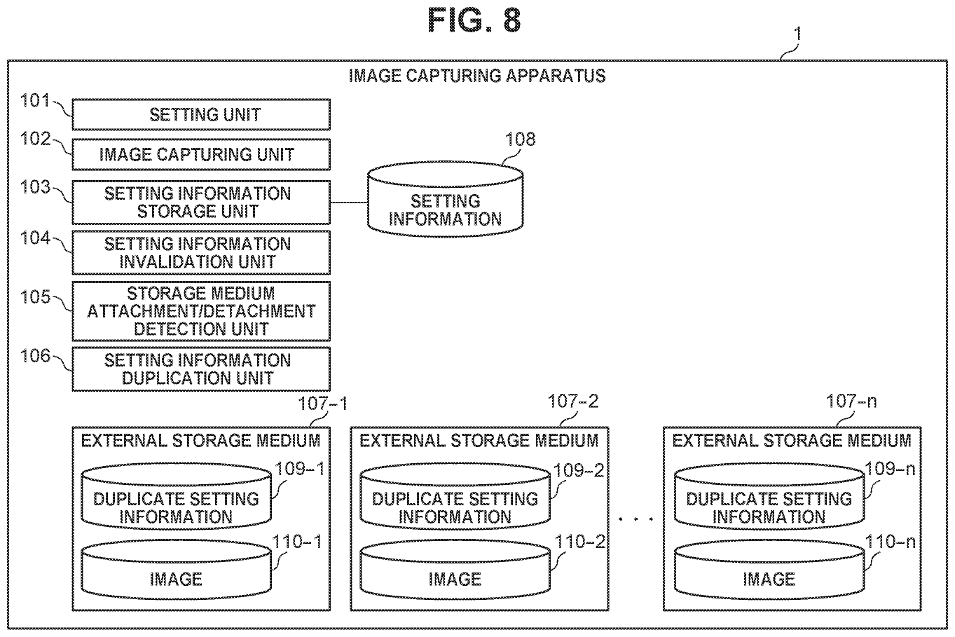

A third exemplary embodiment will now be described. FIG. 8 is a block diagram illustrating an example of a configuration of an image capturing apparatus 1 according to the present exemplary embodiment. According to the first exemplary embodiment, the number of external storage media that can be connected to the image capturing apparatus 1 is one, but “n” number of external storage media 107-1 to 107-n can be connected to the image capturing apparatus 1 of the present exemplary embodiment.

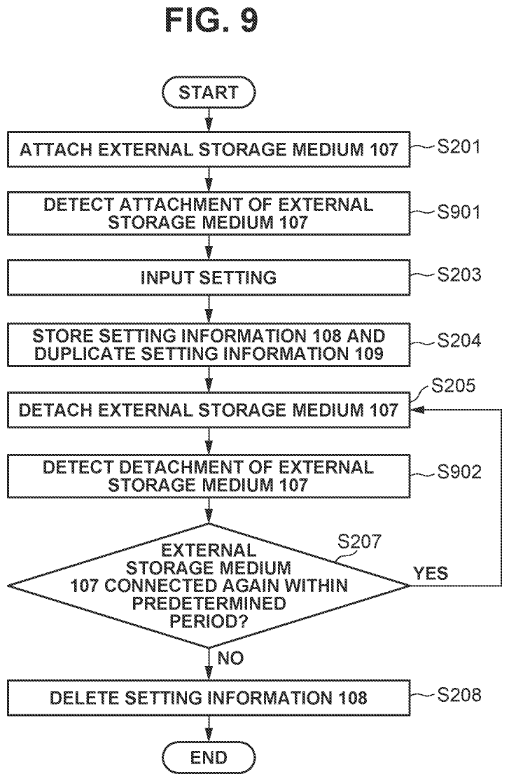

FIG. 9 is a flowchart illustrating processing from generation to deletion of the setting information executed by the image capturing apparatus 1 according to the present exemplary embodiment. According to the present exemplary embodiment, processes in steps S901 and S902 are respectively executed instead of the processes in steps S202 and S206 with respect to the flow in FIG. 2.

In step S901, the storage medium attachment/detachment detection unit 105 detects that any one of the external storage media 107-1 to 107-n are attached to the image capturing apparatus 1 after none of the external storage media 107-1 to 107-n are attached. The storage medium attachment/detachment detection unit 105 notifies the setting unit 101 that attachment of the external storage medium 107 is detected. After receiving the notification that attachment of the external storage medium 107 is detected, the setting unit 101 starts receiving input of setting information from a user. In a case where the external storage medium 107 is attached to the image capturing apparatus 1 when the image capturing apparatus 1 has not been started, the detection is performed, but the notification to the setting unit 101 is performed after the image capturing apparatus 1 is started.

In step S902, the storage medium attachment/detachment detection unit 105 detects that all of the external storage media 107-1 to 107-n are detached from the image capturing apparatus 1 and notifies the setting unit 101 that detachment of the external storage medium 107 is detected. After receiving the notification that detachment of the external storage medium 107 is detected, the setting unit 101 stops receiving input of setting information from the user. In a case where the external storage medium 107 is detached from the image capturing apparatus 1 when the image capturing apparatus 1 has not been started, the detection is performed, but the notification to the setting unit 101 is performed after the image capturing apparatus 1 is started.

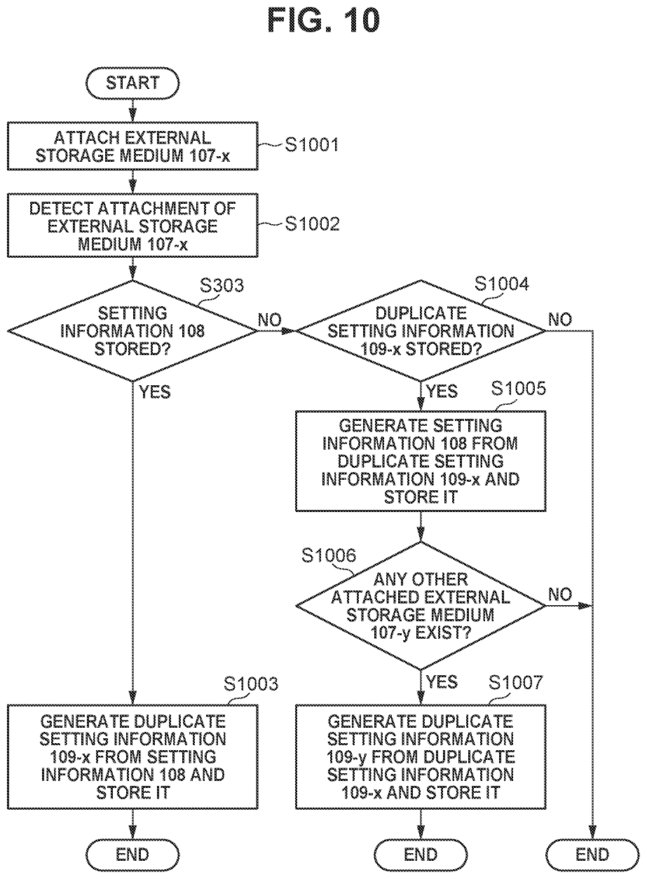

FIG. 10 is a flowchart illustrating an example of setting information duplication executed by the image capturing apparatus 1 according to the present exemplary embodiment.

In step S1001, an external storage medium 107-x, which is one of the external storage media 107-1 to 107-n, is attached to the image capturing apparatus 1.

In step S1002, the storage medium attachment/detachment detection unit 105 detects that the external storage medium 107-x is attached to the image capturing apparatus 1 and notifies the setting information duplication unit 106 that attachment of the external storage medium 107-x is detected. In a case where the external storage medium 107-x is attached to the image capturing apparatus 1 when the image capturing apparatus 1 has not been started, the detection is performed, but the notification to the setting information duplication unit 106 is performed after the image capturing apparatus 1 is started.

Step S303is the same as step S303 in to the first exemplary embodiment.

If in step S303 the setting information 108 is stored, then in step S1003, the setting information duplication unit 106 duplicates the setting information 108 to generate duplicate setting information 109-x. The setting information duplication unit 106 stores the generated duplicate setting information 109-x in the external storage medium 107-x. In a case where valid duplicate setting information 109-x is stored in the external storage medium 107-x, the duplicate setting information 109-x is overwritten and stored.

If in step S303 the setting information 108 is not stored, then in step S1004, the setting information duplication unit 106 determines whether the duplicate setting information 109-x is stored in the external storage medium 107-x. In a case where the duplicate setting information 109-x is stored (YES in step S1004), the processing proceeds to step S1005. In a case where the duplicate setting information 109-x is not stored (NO in step S1004), the processing ends.

In step S1005, the setting information duplication unit 106 duplicates the duplicate setting information 109-x to generate the setting information 108. The setting information duplication unit 106 stores the generated setting information 108 in the setting information storage unit 103.

In step S1006, the setting information duplication unit 106 determines whether there is an external storage medium 107-y connected to the image capturing apparatus 1 other than the external storage medium 107-x. In a case where there is the external storage medium 107-y (YES in step S1006), the processing proceeds to step S1007. If there is no external storage medium 107-y (NO in step S1006), the processing ends.

In step S1007, the setting information duplication unit 106 generates duplicate setting information 109-y from the duplicate setting information 109-x, and stores it in the external storage medium 107-y. There can be a plurality of the external storage media 107-y.

According to the present exemplary embodiment, even in a case where a plurality of external storage media can be connected to the image capturing apparatus, it is possible to detect that all of the external storage media are detached and delete the setting information. The setting information is duplicated among the external storage media and thus can be restored even if any of the external storage media is attached or detached.

According to the above-described exemplary embodiments, processing is performed so that all the setting information is invalidated, but this is not seen to be limiting. For example, setting information with low confidentiality such as time setting, may not be deleted and can continue to be stored in the setting information storage unit 103 even after the external storage medium is detached.

While the above-described exemplary embodiments are described using an image capturing apparatus, this is not seen to be limiting. In another exemplary embodiment, a printing apparatus can be used. For example, in a case of a printing apparatus, the image capturing unit 102 can be replaced with a printing unit, or a function unit to function as a printing apparatus.

According to the above-described exemplary embodiments, the image capturing apparatus 1 is configured to delete the setting information 108 if the external storage medium 107 is detached from the image capturing apparatus 1, but this is not seen to be limiting. For example, even in a case where the external storage medium 107 is detached from the image capturing apparatus 1, if a different external storage medium is connected within a predetermined period of time, the setting information can be duplicated in the different external storage medium without being deleted. At that time, a user can be asked to select either duplicating or not duplicating the setting information to the different external storage medium.

The above-described exemplary embodiments can be implemented as, for example, a system, an apparatus, a control method, a program, or a recording medium (storage medium). Specifically, a system including a plurality of devices (for example, a host computer, an interface device, an image capturing apparatus, and a web application) is applicable, or an apparatus including a single device can also be applicable.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2022-196853, filed Dec. 9, 2022, which is hereby incorporated by reference herein in its entirety.

What is claimed is:

1. An information processing apparatus to which an external storage medium is connectable, the information processing apparatus comprising:
a setting information storage unit configured to store setting information;
an attachment/detachment detection unit configured to detect attachment to and detachment from the information processing apparatus of the external storage medium;
a notification unit configured to provide notification of detachment of the external storage medium from the information processing apparatus; and
an invalidation unit configured to invalidate the setting information based on the notification of the detachment of the external storage medium from the information processing apparatus.

2. The information processing apparatus according to claim 1, wherein the invalidation unit deletes the setting information.

3. The information processing apparatus according to claim 1, further comprising an encryption unit configured to encrypt the setting information.

4. The information processing apparatus according to claim 3, further comprising a decryption unit configured to decrypt the encrypted setting information.

5. The information processing apparatus according to claim 3, wherein the encryption unit stores an encryption key for encryption that is unique to the information processing apparatus.

6. The information processing apparatus according to claim 1, wherein, in a case where the external storage medium is connected to the information processing apparatus within a predetermined period of time after the attachment/detachment detection unit detects detachment of the external storage medium from the information processing apparatus, the invalidation unit does not invalidate the setting information.

7. The information processing apparatus according to claim 1,
wherein the information processing apparatus enables connection of a plurality of external storage media to the information processing apparatus, and
wherein the invalidation unit invalidates the setting information based on detecting that all external storage media detected as being attached to the information processing apparatus are detected to be detached from the information processing apparatus.

8. The information processing apparatus according to claim 1, wherein the external storage medium is a secure digital (SD) card or a compact flash (CF) card.

9. The information processing apparatus according to claim 1, wherein the setting information is authentication information for connecting to an external server.

10. A method for controlling an information processing apparatus to which an external storage medium is connectable, the method comprising:
storing setting information;
detecting attachment to and detachment from the information processing apparatus of the external storage medium;
providing notification of detachment of the external storage medium from the information processing apparatus; and
invalidating the setting information based on the notification.

11. A non-transitory storage medium storing a program causing an information processing apparatus, to which an external storage medium is connectable, to execute a method, the control method comprising:
storing setting information;
detecting attachment to and detachment from the information processing apparatus of the external storage medium;
providing a notification if detachment of the external storage medium from the information processing apparatus; and
invalidating the setting information based on the notification.
